(19) United States
(12) Patent Application Publication
(10) Pub. No.: US 2018/0364028 A1
(43) Pub. Date: Dec. 20, 2018

(54) DEVICE AND METHOD FOR MEASURING HEIGHT IN THE PRESENCE OF THIN LAYERS

(71) Applicant: UNITY SEMICONDUCTOR, Montbonnot-aint-Martin (FR)

(72) Inventors: Jean-Philippe PIEL, L'Étang-la-Ville (FR); Jeff WuYu SU, Tainan City (TW); Benoît THOUY, Montpellier (FR)

(21) Appl. No.: 16/061,268

(22) PCT Filed: Dec. 7, 2016
(86) PCT No.: PCT/EP2016/080005

§ 371 Date: Jun. 11, 2018

(30) Foreign Application Priority Data
Dec. 22, 2015 (FR) 1563128

(51) Int. Cl. G01B 11/06; G01B 9/02

(52) U.S. Cl. CPC G01B 11/0675; G01B 9/02021; G01B 9/02027; G01B 9/02044; G01B 2290/35; G01B 9/02065; G01B 9/0209; G01B 2210/44; G01B 2210/48; G01B 9/02057

(57) ABSTRACT

A device for measuring heights and/or thicknesses on a measurement object, includes (i) a first low-coherence interferometer for combining, in one spectrometer, a reference optical beam and a measurement optical beam originating from reflections of the light on interfaces of the measurement object, to produce a grooved spectrum signal with spectral modulation frequencies, (ii) apparatus for measuring an item of position information representative of the relative optical length, (iii) electronic and calculating apparatus arranged for determining at least one spectral modulation frequency representative of an optical path difference between the measurement optical beam and the reference optical beam, and for determining, by exploiting the item of information and the spectral modulation frequency, at least one height and/or thickness on the measurement object, and (iv) second optical apparatus for measuring distance and/or thickness with a second measurement beam incident on the measurement object on a second face opposite the measurement beam.

### TECHNICAL FIELD

The present invention relates to a device and a method for measuring heights or thicknesses of samples such as wafers in the presence of thin layers.

The field of the invention is more particularly, but non-limitatively, the field of optical measuring systems for the semiconductor industry.

### STATE OF THE ART

It is often necessary to perform measurements of height, shape or thickness on wafers during the manufacturing processes of semiconductor components. These measurements can relate for example to surface shapes or flatness, total thicknesses, or thicknesses of layers.

To this end, the use of optical techniques is known, including in particular the techniques of low-coherence interferometry that implement wide-spectrum optical sources. These techniques are essentially of two kinds:
techniques with detection in the time domain;
techniques with detection in the spectral domain.

The techniques with detection in the time domain use a time delay line that makes it possible to reproduce the delays in propagation of the measurement waves reflected by interfaces of the object to be measured and cause them to interfere with a reference wave. Interference peaks representative of the position of the interfaces of the object are thus obtained on a detector. These temporal techniques make it possible to reach significant measurement ranges, limited only by the length of the delay line. By using a wide-spectrum source emitting in the infrared, they make it possible to measure thicknesses of semiconductor materials such as silicon. The minimum thicknesses that can be measured are limited by the width of the envelope of the interferograms, which depends on the shape and width of the spectrum of the source.

Thus, with a superluminescent diode emitting in the infrared (1310 nm or 1550 nm for example), it is possible to measure thicknesses of silicon or of transparent layers of the order of some tens of microns to several millimetres.

The techniques based on spectral-domain low-coherence interferometry are generally intended more for measurements of thin layers, of the order of some tens of nanometres to some hundreds of microns. The light reflected by the interfaces of the object to be measured is analysed in a spectrometer. The thicknesses or distances between interfaces of the object at the origin of the reflections introduce modulations in the detected spectrum, which make it possible to measure them.

For example, document EP 0 747 666 is known, which describes a system based on spectral-domain low-coherence interferometry, allowing distances between interfaces to be measured in the presence of thin layers, based on mathematical modelling of the phase of the undulations of the spectrum being measured.

In practice, the wafers the thickness of which one wishes to measure can be covered with a thin layer of transparent material. For example, configurations are encountered in which one wishes to measure the thickness of silicon wafers with a thickness from 300 μm to 700 μm covered with a layer of polyimide with a thickness of the order of 10 μm. This configuration is problematic as none of the techniques mentioned above allows satisfactory measurement of the total thickness:
The techniques of low-coherence interferometry with detection in the time domain (and an infrared source) allow the thickness of silicon to be measured, but they do not allow the interfaces of the thin layer of polyimide to be distinguished, which are too close compared to the width of the interferograms. Even if one does not wish to know the thickness of the thin layer, it leads to a measurement uncertainty of the order of its thickness;
The techniques of low-coherence interferometry with detection in the spectral domain allow the thickness of the thin layer to be measured, but their measurement range is too limited for measuring the thickness of silicon.

The objective of the present invention is to propose a device and a method for measuring heights of objects such as wafers in the presence of thin layers.

Another objective of the present invention is to propose a device and a method for measuring thicknesses of objects such as wafers in the presence of thin layers.

Another objective of the present invention is to propose a device and a method for measuring heights or thicknesses of objects such as wafers in the presence of thin layers without degradation of the measurement accuracy.

Another objective of the present invention is to propose a device and a method for measuring heights or thicknesses of objects such as wafers, with both a wide measurement range and a resolution allowing thin layers to be measured.

### DISCLOSURE OF THE INVENTION

This objective is achieved with a device for measuring heights and/or thicknesses on a measurement object such as a wafer,

comprising a first low-coherence interferometer illuminated by a polychromatic light and arranged in order to for combine, in one spectrometer, a reference optical beam originating from a reflection of said light on a reference surface and a measurement optical beam originating from reflections of said light on interfaces of the measurement object, so as to produce a grooved spectrum signal with spectral modulation frequencies,

characterized in that it further comprises:
displacement means for varying the relative optical length of the measurement optical beam and the reference optical beam, and means for measuring an item of position information representative of said relative optical length,
electronic and calculating means arranged for determining at least one spectral modulation frequency representative of an optical path difference between the measurement optical beam and the reference optical beam, and for determining, by exploiting said item of position information and said at least one spectral modulation frequency, at least one height and/or thickness on said measurement object, and
second optical means for measuring distance and/or thickness with a second measurement beam incident on the measurement object on a second face opposite the measurement beam.

The displacement means for varying the relative optical length of the measurement optical beam and the reference optical beam (or in other words the difference in optical length of the measurement optical beam and the reference optical beam) can for example comprise a mechanical translation device for moving:
the reference surface relative to a beam splitting element of the interferometer, so as to vary the length of the reference optical beam;
the whole interferometer relative to the object to be measured, or the object relative to the interferometer, so as to vary the length of the measurement optical beam.

The means for measuring an item of position information can comprise any means, such as an optical ruler or a laser telemeter, for measuring the position of the moving element.

The polychromatic light can comprise a spectrum extending into visible wavelengths and/or infrared wavelengths.

The spectrum signal is said to be “grooved” (“grooved spectrum”) when the difference in relative optical length of the measurement optical beam and the reference optical beam is large enough to allow identification of at least one spectral modulation period in the spectrum signal (therefore over the spectral width of the spectrum signal). In this case, the spectrum signal shows oscillations as a function of the wavelength or frequency, i.e. an amplitude that varies periodically with the wavelength or frequency. Of course, the spectrum signal can also comprise modulations of period greater than the spectral width of the spectrum signal, corresponding to very thin layers.

According to embodiments, the device according to the invention can comprise a measuring head with the reference surface, and means for translational movement suitable for the relative displacement of said measuring head and the measurement object in a direction substantially parallel to an optical axis of the measurement optical beam.

In this case, the displacement means make it possible to vary the optical length of the measurement beam relative to the reference beam.

According to embodiments, the device according to the invention can comprise a reference surface in the form of a semi-reflective plate inserted in the path of the measurement optical beam.

According to other embodiments, the device according to the invention can comprise a measuring head with a beam-splitting optical element suitable for generating separate measurement and reference optical beams.

The device according to the invention can in particular comprise a measuring head with a first interferometer of one of the following types: Mirau, Linnick, Michelson, for generating the measurement optical beam and the reference optical beam.

A Mirau interferometer comprises a beam-splitting optical element with a semi-reflective plate perpendicular to the axis of the incident beam and a reference surface in the form of a mirror inserted at the centre of the incident beam.

A Michelson interferometer or a Linnick interferometer comprise a beam-splitting optical element with a semi-reflective plate or a splitter cube arranged for generating a measurement beam and a reference beam that are substantially perpendicular, and a reference surface in the form of a mirror inserted in the reference beam.

A Linnick interferometer further comprises lenses or objectives inserted in the arms of the interferometer corresponding to the reference beam and the measurement beam.

The device according to the invention can further comprise second translation means suitable for the relative displacement of the measurement optical beam and the measurement object in a plane substantially perpendicular to an optical axis of the measurement beam.

These second translation means make it possible to displace the measurement optical beam over the surface of the object (or vice versa) so as to be suitable for measuring heights and/or thicknesses at different points of said object.

The device according to the invention can further comprise a support suitable for receiving the measurement object, and a reference object with a known height and/or thicknesses arranged on or forming part of said support.

The support can for example be a wafer chuck, for receiving a measurement object in the form of a wafer.

The reference object can for example be a portion of a wafer with known characteristics placed on or integral with the support. It can also be constituted by a portion of the support or chuck of calibrated height.

The reference object can also be constituted by a bearing face of the support intended to receive the object to be measured, or a surface coplanar with this bearing face.

The reference object allows the measurement system to be calibrated, by performing measurements of known heights and/or thicknesses on its surface.

According to embodiments, the device according to the invention can comprise a first low-coherence interferometer illuminated by a polychromatic light, which emits light in the visible spectrum.

Such a wide-spectrum source with quite short wavelengths makes it possible to perform measurements of thin layers, for example transparent dielectric materials from some tens of nanometres to some microns.

As explained above, the device according to the invention can further comprise second optical means for measuring distance and/or thickness with a second measurement beam incident on the object to be measured on a second face opposite the measurement beam.

This configuration makes it possible to perform calliper measurements, for example for performing measurements of total thickness on the measurement object. These measurements of total thickness can in particular be deduced from measurements of distances performed on either side of the measurement object.

The second optical means for measuring distance and/or thickness can also be calibrated by performing measurements on the reference object.

According to other embodiments, the device according to the invention can further comprise second mechanical means for measuring distance with a mechanical probe in contact with a second face of the object to be measured opposite the measurement beam.

According to embodiments, the device according to the invention can comprise second optical means for measuring distance and/or thickness of one of the following types:
spectral-domain low-coherence interferometer,
chromatic confocal system.

In the case of a spectral-domain low-coherence interferometer, it can be identical to or different from the first interferometer. It can also implement light with visible and/or infrared wavelengths.

A chromatic confocal system is a measurement system that uses a dispersive optical element for focusing different wavelengths at different distances, and a spectral detection for identifying the reflected wavelengths and thus the position of the interfaces giving rise to these reflections.

According to embodiments, the device according to the invention can comprise second optical means for measuring distance and/or thickness with a time-domain low-coherence interferometer.

This time-domain low-coherence interferometer can comprise a delay line that allows a (time) delay between optical beams to be varied.

According to embodiments, the time-domain low-coherence interferometer can comprise a light source emitting in the infrared.

According to embodiments, the time-domain low-coherence interferometer can comprise a double Michelson interferometer with an encoding interferometer and a decoding interferometer, and a measurement optical fibre with a collimator for generating the second measurement optical beam.

The decoding interferometer can comprise a delay line arranged so as to reproduce an optical delay between a measurement beam originating from reflections on interfaces of the measurement object and a reference beam. This delay line can for example comprise a mirror that is movable in translation along the axis of the optical beam, or any other means known to a person skilled in the art for varying an optical path (optical fibres that have undergone stretching, rotating plate with parallel faces, etc.).

The reference beam can be generated in the collimator, for example by the Fresnel reflection at the interface between the end of the measurement optical fibre and the air.

The advantage of such an interferometer is that it can be easily integrated, as the core of the interferometer can be remote from the measurement object and only the collimator must be placed in proximity to this object.

It has the advantage of allowing wide measurement ranges, depending on the delay line selected (of several millimetres or even several centimetres).

It also has the advantage of allowing measurements of “true” distances, from the point of generation of the reference beam in the collimator to the interfaces of the object, which are precise (for example of the order of 100 nm) and are not sensitive to perturbations, in particular in the measurement optical fibre. Moreover, as the distances are measured from one and the same reference, it is possible to reconstruct unambiguously the structure of the stacks of layers of the measurement object.

The use of an infrared light source makes measurements of distances and thicknesses possible, including through materials such as silicon which is opaque to visible light but is sufficiently transparent in the infrared.

According to another aspect, a method is proposed for measuring heights and/or thicknesses on a measurement object such as a wafer, implementing a first low-coherence interferometer illuminated by a polychromatic light and arranged for combining, in one spectrometer, a reference optical beam originating from a reflection of said light on a reference surface and a measurement optical beam originating from reflections of said light on interfaces of the measurement object, so as to produce a grooved spectrum signal with spectral modulation frequencies, said method comprising steps of:
measuring an item of position information representative of the relative optical length of the measurement optical beam and the reference optical beam,
determining at least one spectral modulation frequency representative of an optical path difference between the measurement optical beam and the reference optical beam,
determining, by exploiting said item of position information and said at least one spectral modulation frequency, at least one height and/or thickness on said measurement object,
measuring a second item of information on height and/or thicknesses using second optical means for measuring distance and/or thickness with a second measurement beam incident on the object to be measured on a second face opposite the measurement beam, so as to determine an item of thickness information of said object to be measured.

The method according to the invention can further comprise a step of identifying the spectral modulation frequencies the value of which varies with a variation of the relative optical length of the measurement optical beam and the reference optical beam.

The method according to the invention can further comprise a step of varying the relative optical length of the measurement optical beam and the reference optical beam so as to obtain at least one spectral modulation frequency in a predetermined range of values.

According to some methods of implementation, the method according to the invention can further comprise steps of:
calculating a spectral modulation signal representative of the amplitude of the Fourier transform of the grooved spectrum signal,
identifying amplitude peaks representative of spectral modulation frequencies in said spectral modulation signal.

According to implementation modes, the method according to the invention can further comprise a calibration step comprising a measurement of height and/or thickness on a reference object of known height and/or thickness, so as to establish a relationship between at least one item of position information of the reference surface, at least one spectral modulation frequency, and at least one height and/or thickness.

According to implementation modes, measurement of a second item of information of height and/or thicknesses can comprise steps of:
generating the second measurement optical beam and a reference optical beam by means of a measurement optical fibre and a collimator,
determining optical path differences between the second measurement optical beam reflected on the measurement object and the reference beam by implementing a double Michelson interferometer with an encoding interferometer and a decoding interferometer provided with a time delay line.

According to a particularly advantageous aspect, the method of measurement according to the invention implements a low-coherence interferometer with spectral mode detection in a configuration that makes it possible to perform measurements of absolute distances over relatively large measurement ranges. It is thus possible to exploit an advantage of this type of spectral detection, which is that it makes it possible to distinguish interfaces that are very close, and to obtain a device and a method of measuring distances and/or thicknesses that combines a large measurement range as well as a high resolution (or capacity to distinguish close interfaces).

To this end:
the difference in relative optical length of the measurement optical beam and the reference optical beam is adjusted by displacing in a known manner an element of the interferometer (or the measurement object) so that the corresponding spectral modulation frequency of the grooved spectrum signal is in a range of values where it can be measured under good conditions;
this item of information on the displacement of an element of the interferometer as well as the spectral modulation frequency or frequencies measured is used for calculating an absolute height of the measurement object;
the measurement is calibrated on a reference object of known height in order to establish a relationship between the item of information on displacement of an element of the interferometer and the absolute height;

For measuring a thickness of an object, another measurement is performed on the opposite face of the object, with a similar or different device, optical or even mechanical (contact probe).

As described above, a time-domain low-coherence interferometer can advantageously be used operating in the infrared with a large measurement range, which makes it possible to obtain complete measurement of the structure of the layers of the object that are transparent in the infrared. In this way two measurement techniques are combined that are very complementary, making it possible to obtain very complete characterization of the object.

### DESCRIPTION OF THE FIGURES AND EMBODIMENTS

Other advantages and characteristics of the invention will become apparent on examination of the detailed description of an embodiment which is in no way limitative, and the attached diagrams, in which:

FIG. 1 shows an embodiment of the device according to the invention,

FIG. 2 shows an embodiment of the interferometer in the form of a Michelson interferometer,

FIG. 3 shows an embodiment of the interferometer in the form of a Mirau interferometer,

FIG. 4 shows (a) a grooved spectrum signal, and (b) a Fourier transform of the grooved spectrum,

FIG. 5 shows the steps of the method according to the invention,

FIG. 6 shows an embodiment of second optical measurement means.

It is well understood that the embodiments that will be described below are in no way limitative. In particular, it is possible to imagine variants of the invention comprising only a selection of the characteristics in no way limitative. It is possible to envisage variants of the invention comprising described hereinafter, in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In particular, all the variants and all the embodiments described can be combined together if such a combination is not ruled out technically.

In the figures, elements common to several figures retain the same reference.

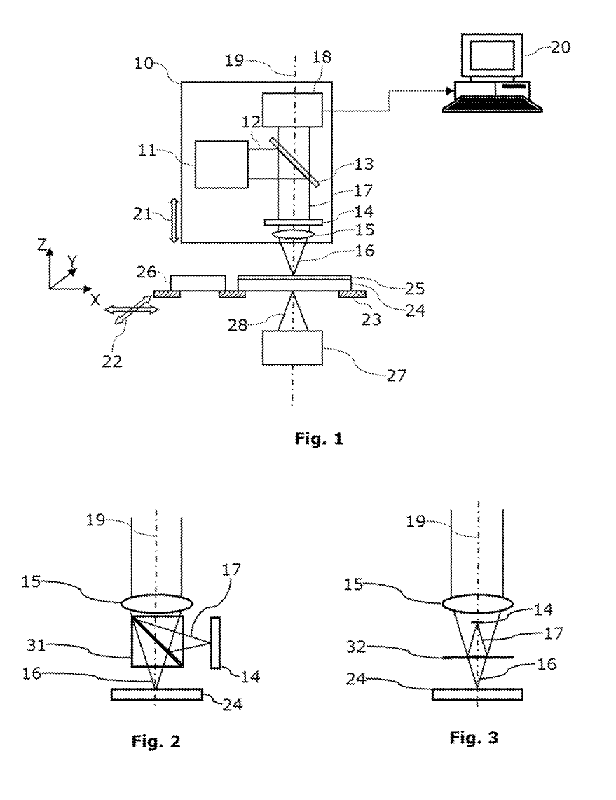

A first embodiment of the device according to the invention for measuring heights or thicknesses of measurement objects 24 will be described, with reference to FIG. 1.

In the embodiment presented, the device according to the invention is intended more particularly for measuring measurement objects 24 in the form of wafers 24 while they are being processed.

As shown, these wafers 24 can comprise one or more thin layers 25 deposited on their surface.

These wafers 24 can for example comprise a thickness of silicon from 450 μm to 700 μm and a layer of polyimide, silicon oxide, silicon nitride or other transparent dielectrics from some tens of nanometres to some microns.

Usually these thin layers are at least partially transparent at visible wavelengths. Silicon is transparent at infrared wavelengths. However, depending on the samples, the layer of silicon can comprise opaque layers (component, transistors, metal layers or tracks etc.).

Under these conditions, as explained above, the known methods for measuring the total thickness of the wafer are not generally suitable for separating or resolving the interfaces of the thin layers, especially when they are transparent at the measurement wavelengths. Even if one does not wish to measure the thickness of these layers, but only the total thickness of the wafer 24, the measurement accuracy is limited by the uncertainty in the detection of the interfaces of the thin layers 25.

Conversely, these thin layers can be measured or their interfaces distinguished using techniques of low-coherence interferometry operating in the spectral domain, using a light source with a spectrum with a sufficiently wide range of frequencies. Nevertheless, these techniques cannot be used for measuring large optical thicknesses (such as 700 μm of silicon, which corresponds to an optical thickness above 2 mm after taking into account the refractive index of silicon, which is of the order of 3.5) as the oscillations of the grooved spectrum become too close to be sampled by the detector.

Moreover, the wafers 24 to be measured can be greatly deformed, which requires a measurement system with a wide measurement range.

The core of the measuring device according to the invention is constituted by a low-coherence interferometer integrated in a measuring head 10.

The measuring head 10 is fixed to displacement means 21 with a motorized translation stage which allows it to be displaced along an axis Z relative to the frame of the apparatus on which this translation stage is fixed. The translation stage is equipped with means for measuring an item of position information in the form of an optical ruler, enabling its displacement and its position to be measured accurately.

The interferometer is illuminated by a broadband light source 11, which emits polychromatic light 12 in the visible spectrum. In the embodiment presented, this source comprises a halogen source, or deuterium halogen source, with a spectrum extending to 300 nm in the ultraviolet.

The interferometer comprises a beam splitter 13, which directs the light from the source 11 to the object to be measured 24.

Part of the light is reflected on a reference surface 14 constituted by a semi-reflective plate 14, in order to form a reference optical beam 17.

Part of the light from the source is transmitted through the semi-reflective plate 14 in order to form a measurement optical beam 16. This measurement optical beam 16 is focused on the object to be measured 24 (wafer 24) by an objective or a lens 15.

The measurement optical beam 16 is positioned relative to the measurement object 24 so that its optical axis 19 is substantially perpendicular to the interfaces of this object 24. In the embodiment presented, this optical axis 19 is substantially parallel to the displacement axis Z of the displacement means 21.

The light of the measurement beam 16 is reflected on the interfaces of the object to be measured 24, and in particular, in the example shown, by the interfaces of the thin layer 25.

The reflected measurement beam 16 and reference beam 17 are directed through the beam splitter 13 to a detection spectrometer 18.

This spectrometer 18 comprises a diffraction grating, which scatters spatially as a function of the optical frequencies the combined light of the measurement beam 16 and reference beam 17, and a linear sensor (CCD or CMOS), each pixel of which receives the light originating from the diffraction grating corresponding to a particular range of optical frequencies.

The spectrometer is connected to electronic and calculating means 20 in the form of a computer 20.

The object to be measured 24, which in the embodiment shown is a wafer 24, is positioned on a support 23, which has the form of a wafer chuck 23.

The device further comprises a reference object 26 in the form of a portion of wafer 26 of known thickness. This reference object 26 is positioned on wafer chuck 23.

The wafer chuck 23 is fixed on second translation means 22 in the form of a translation stage 22 which ensures the displacement thereof (relative to the frame of the apparatus for example) in an X-Y plane substantially perpendicular to the optical axis 19 of the measurement beam 16.

These second translation means 22 make it possible to position the measurement beam 16 at every point of the surface of the wafer 24, and on the reference object 26.

The device according to the invention furthermore comprises second optical means for measuring distance and/or thickness 27 with a second measurement beam 28 incident on the object to be measured 24 on a second face opposite the measurement beam 16.

In the embodiment presented, these second optical measurement means 27 comprise a low-coherence interferometer 27 operating in the time domain, with a time delay line, which makes it possible to introduce a variable delay or variation in optical path.

Such interferometers are known to a person skilled in the art, so only the general principles will be recalled here.

The light originating from a wide-spectrum source is split into an internal reference beam and a measurement beam 28 incident on the object to be measured. The measurement beam 28 is reflected on interfaces of the object. Each reflection is subject to a delay proportional to the optical path to the interface under consideration. This delay is reproduced in the delay line so as to bring the measurement and reference beams back into phase and thus generate interference peaks during displacement of the delay line. The knowledge of the displacement of this delay line makes it is possible to determine the position of the interfaces giving rise to the interference peaks.

Preferably a light source in the infrared is used (around 1310 nm for example), which makes it possible to penetrate silicon and thus also perform measurements on layers inside the wafer if required.

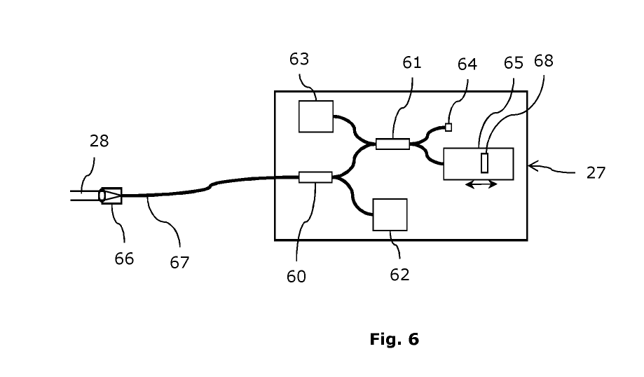

FIG. 6 shows a diagrammatic representation of a low-coherence interferometer 27 of this kind, operating in the time domain.

The core of the interferometer 27 is a double Michelson interferometer based on single mode optical fibres, with an encoding interferometer 60 and a decoding interferometer 61. It is illuminated by a fibre light source 62, which is a superluminescent diode (SLD) central wavelength of which is of the order of 1300 nm to 1350 nm and the spectral width is of the order of 60 nm. The choice of this wavelength is in particular based on criteria of availability of the components.

The light from the source 62 is directed through a coupler 60, which constitutes the encoding interferometer 60, and a measurement optical fibre 67 to a collimator 66, in order to constitute the second measurement beam 28.

A part of the beam originating from the source 62 is reflected in the measurement fibre 67 at the collimator 66, in order to constitute the internal reference beam. More precisely, in the embodiment presented, the reference beam is generated by the Fresnel reflection at the interface between the end of the measurement optical fibre 67 and the air in the collimator. This reflection is usually of the order of 4%.

The retroreflections originating from the interfaces of the wafer 24 are coupled in the fibre 67 and directed with the reference wave to the decoding interferometer 61 constructed around the fibre coupler 61. This decoding interferometer functions as an optical correlator the two arms of which are, respectively, a fixed reference 64 and a time delay line 65. The signals reflected at the reference 64 and the delay line 65 are combined, via coupler 61, on a detector 63, which is a photodiode. The function of the delay line 65 is to introduce an optical delay between the incident and reflected waves, which is variable over time in a known manner. This delay is obtained for example by the displacement of a mirror 68 in translation along the axis of the optical beam.

The length of the arms 64 and 65 of the decoding interferometer 61 is adjusted so as to make it possible to reproduce, with the delay line 65, the optical path differences between the reference wave reflected at the collimator 66 and the retroreflections from the object to be measured 24. When this optical path difference is reproduced for a position of the mirror 68, an interference peak shape and width of which depend on the spectral characteristics of the source 62 (the wider the spectrum of the source 62, the narrower the interference peak) is obtained on the detector 43.

Thus, the measurement range is determined by the difference in optical length between the arms 64 and 65 of the decoding interferometer 61, and by the maximum length of the delay line 65. Interferometers of this type thus have the advantage of allowing wide measurement ranges. Moreover, as the successive interfaces of the object to be measured 24 appear as successions of interference peaks separated by the optical distances separating these interfaces (as reproduced for example by the travel of the mirror 68), stacks of numerous layers can be measured unambiguously.

By implementing a double interferometer system, with an encoding interferometer 60 and a decoding interferometer 61, and generating the reference at the end of the measurement fibre 67, it is possible to make the system insensitive to the perturbations in the measurement fibre 67. Thus, the true optical distances between the collimator and the interfaces of the object to be measured 24 can be measured very accurately.

Moreover, this configuration with a measurement optical fibre 67 makes it possible to move the interferometer 27 away. Thus, only the collimator 66 is in the proximity of the object to be measured 24. This is an important advantage when the object to be measured 24 is a wafer 24 on a wafer chuck 23, for which access via its face on the wafer chuck 23 is more difficult.

The use of two measurement beams 16, 28 on either side of the object to be measured 24 in a “calliper” configuration makes it possible to perform measurements of thickness on this object 24 by measuring the distances of its faces on either side relative to the measurement systems. It is thus possible to determine the thickness of the object 24 in all cases, whether it is transparent, opaque, or partially opaque at the measurement wavelengths used.

Of course, the second translation means 22 also allow the second measurement beam 28 to be positioned at any point of the second surface of the wafer 24, and on a second face of the reference object 26 opposite the first measurement beam 16.

It should be noted that the combination of:
a technique of low-coherence interferometry operating in the spectral domain and using a light source with a very broad spectrum
and a technique of low-coherence interferometry operating in the time domain in the infrared,
in a calliper configuration as described above,

allows very complete characterization of samples such as wafers with dielectric thin layers, owing to the great complementarity of these measurement techniques.

FIGS. 2 and 3 show variants of embodiments of the interferometer that have the advantage of spatially separating the measurement beam 16 and reference beam 17. These configurations in particular make it possible to increase the working distance between the interferometer and the object to be measured 24 without increasing the optical path difference between the measurement beam 16 and reference beam 17.

FIG. 2 shows a configuration of a Michelson interferometer. The light from the source is split by a splitter cube 31 in order to form a measurement beam 16 directed onto the object 24 and a reference beam 17 directed onto a reference surface in the form of a mirror 14. The measurement and reference beams are substantially perpendicular.

FIG. 3 shows a configuration of a Mirau interferometer. The light from the source is split by a semi-reflective plate 32 approximately perpendicular to the optical axis 19 of the incident beam in order to form a measurement beam 16 directed onto the object 24 and a reference beam 17 directed onto a reference surface in the form of a mirror 14. In this case the reference mirror 14 is on the optical axis 19 of the incident beam, forming a central obscuration thereof.

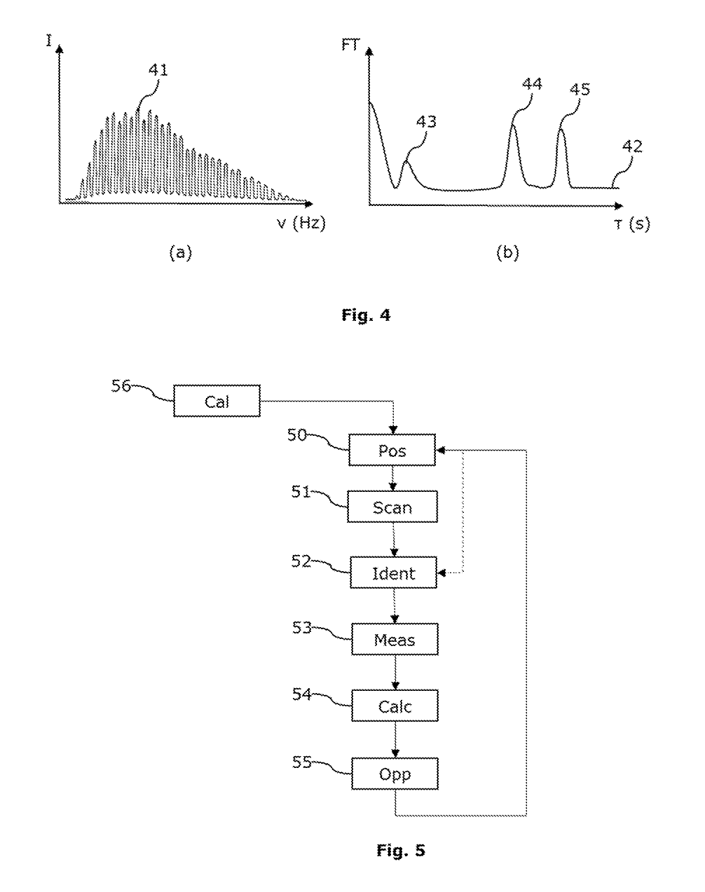

FIG. 4(a) shows a grooved spectrum signal 41 such as is obtained at the output of the spectrometer 18.

This signal represents a spectral intensity I(v) expressed as a function of the optical frequency v. This intensity I(v) can be represented as a sum of i harmonic functions each corresponding to an interference signal between two waves incident on the spectrometer 18:

I(v)˜A₀(v)+Σᵢ{Aᵢ(v)cos [(2n/c)2Lᵢv+φᵢ]}

where A₀ and Aᵢ are intensity coefficients, φᵢ is a phase coefficient, c is the speed of light, and 2 Lᵢ is the optical path difference between the two interfering waves.

The “frequency” of spectral modulation of each of these harmonic functions (which in fact has a dimension of time and corresponds to the delay between the two waves that interfere) can be written:

τᵢ=(2Lᵢ/c).

This “frequency” of spectral modulation is therefore representative of the optical path difference 2Lᵢ between the two waves that interfere.

In order to analyse the signal of spectral intensity I(v), a Fourier transform is performed thereon, and an amplitude spectrum or spectral modulation signal 42 is obtained, as shown in FIG. 4(b). It should be noted that this spectral modulation signal 42 is representative of an envelope of the temporal autocorrelation function of the measurement 16 and reference 17 beams. It comprises an amplitude peak 43, 44, 45 for each delay τᵢ corresponding to an optical path difference 2Lᵢ between two waves that interfere.

The spectral modulation signal 42 shown in FIG. 4(b) corresponds qualitatively to the situation shown in FIG. 1, in which one has a measurement object 24 with a thin layer 25.

Of course, the signals shown in FIG. 4(a) and FIG. 4(b) are purely illustrative.

The spectral modulation signal 42 comprises a first peak 43 centred on a delay τ corresponding to the optical path difference 2E, where E is the optical thickness of the thin layer 25. This first peak 43 therefore corresponds to interference between two components of the measurement beam 16 reflected on the two interfaces of the object 24 situated on either side of the thin layer 25.

It also comprises a second peak 44 and a third peak 45 corresponding respectively to interferences between the reference beam 17 and the components of the measurement beam 16 reflected on the respective interfaces of the object 24 situated on either side of the thin layer 25.

Only these second and third peaks 44, 45 and the associated spectral modulation frequencies are representative of an optical path difference between the measurement optical beam 16 and the reference optical beam 17. Therefore only these second and third peaks 44, 45 contain information on the absolute height of the object.

It is therefore necessary, for performing a height measurement on the object 24, to be able to discriminate the peaks 43 due solely to interferences between components of the measurement beam 16 and the peaks of interest 44, 45 that are due to interferences between the reference beam 17 and the measurement beam 16 and which alone contain useful information.

To this end, the measuring head 10 is displaced relative to the object to be measured 24 with the displacement means 21, which varies the optical path difference between the measurement beam 16 and the reference beam 17. Only the peaks of interest 44, 45 due to interferences between the reference beam 17 and the measurement beam 16 are displaced in the measurement range, making it possible to distinguish them from the others that remain stationary. Moreover, it is therefore possible to position them in a preferred zone of the measurement range where they can be distinguished and measured under good conditions. To this end, the peaks of interest 44, 45 are positioned:
in the exploitable measurement range (in terms of delays τ or optical path differences 2L). This measurement range extends from zero (zero delay) to delays for which the spectral modulation frequencies can no longer be sampled owing to the spectral resolution of the spectrometer.
preferably in a zone of the measurement range corresponding to delays τ or optical path differences 2L greater than those corresponding to the thickness of the thin layers 25 of the object 24.

If the thickness of a thin layer 25 of the object 24 is sufficiently large, the measuring head 10 can also be positioned relative to the object 24 so that the length of the optical path of the reference optical beam 17 is intermediate between the lengths of the optical paths of the measurement beam 16 as reflected by the respective interfaces of the thin layer 25. In this case, the reference surface 14 appears optically as being between the interfaces of the thin layer 25, and the peaks of interest 44, 45 are located at delays τ (or optical path differences 2L) less than that corresponding to the thickness of the thin layer 25 of the object 24.

It should be noted that:
the total measurement range is thus determined essentially by the stroke of the displacement means 21, and
the resolution, i.e. the ability to discriminate close interfaces, is determined by the resolution of spectral detection.

As explained above, the interferometer makes it possible to determine optical path differences 2Lᵢ between the reference beam and the measurement beam reflected by the interfaces of the object 24. It therefore makes it possible to determine the optical heights Lᵢ of these interfaces relative to an origin defined by an equality of optical path in the interferometer.

It will be recalled that optical distances or heights correspond to geometric distances or heights multiplied by the refractive index of the media traversed. In the embodiment in FIG. 1, these heights Lᵢ correspond to the optical distance between the reference surface 14 and the interfaces of the object 24 along the Z axis.

In order to calculate the optical height Huᵢ of the interfaces of the object 24 relative to an origin of a coordinate system (X, Y, Z) as shown in FIG. 1, it is necessary to take into account the position P_{H} of the interferometer or of the measuring head 10 along the Z axis. This position P_{H} is given by the position measuring means of the translation stage 21, after calibration. Considering a position P_{H} and optical heights Huᵢ oriented along the Z axis, the optical height Huᵢ of the interfaces of the object 24 is given by the relationship:

Huᵢ=P_{H}−Lᵢ.

It is also possible to obtain measurements of optical height HIⱼ of the interfaces of the measurement object 24 on its opposite face in a similar manner with the second optical measurement means 27. Preferably, these measurements of optical height HIⱼ are measured relative to the same origin of the coordinate system (X, Y, Z).

The optical thicknesses T of the object can then be determined by adding (or subtracting, depending on the sign conventions) the optical heights Hu and HI obtained on the two faces of the object 24.

With reference to FIG. 5, a method for measuring distances and/or thickness that uses the device of the invention will now be described.

In order to perform a measurement:
the measurement beam is positioned on the surface of the object to be measured 24 by means of the second translation means 22 (step 50);
the measuring head 10 is displaced in the Z direction relative to the object to be measured 24 with the displacement means 21 for varying the optical path difference between the measurement beam 16 and the reference beam 17 (step 51);
the peak or peaks of interest 44, 45 are identified as explained above and/or they are positioned in a preferred zone of the measurement range (step 52);
the optical path difference or differences Lᵢ corresponding to these peaks of interest 44, 45 are measured in the measurement range of the interferometer (relative to the zero delay corresponding to equality of optical paths of the measurement beam 16 and the reference beam 17) (step 53);
the optical height Huᵢ of the interfaces of the object 24 is calculated, taking into account the position P_{H} of the interferometer as described above (step 54);
in order to calculate a thickness of the object, a measurement of the optical height HIⱼ of the interfaces of the measurement object 24 is also performed on its opposite face with the second optical measurement means 27, and the optical heights Hu and HI are combined in order to determine the (optical) thickness T (step 55).

The measurement beams can then be moved to another point of the surface of the object 24 in order to perform another measurement and thus produce a mapping or topology of the object 24.

Step 51 of displacement of the measuring head 10 can be omitted between the measurement points at the surface of the object if identification of the peaks of interest is retained.

The method according to the invention also comprises a calibration step 56 that makes it possible to determine the value of the position P_{H} of the interferometer or measuring head 10 along the Z axis. To this end, one or more measurements are performed on the reference object 26 the height Hu of which is known, and the value of the position P_{H} is deduced therefrom. In a similar way it is also possible to calibrate the second optical measurement means 27.

This calibration procedure can be carried out once before performing a set of measurements on the surface of an object 24.

Of course, the invention is not limited to the examples which have just been described and numerous adjustments can be made to these examples without exceeding the scope of the invention.

1. A device for measuring heights and/or thicknesses on a measurement object such as a wafer, comprising: a first low-coherence interferometer illuminated by a polychromatic light and arranged for combining, in one spectrometer, a reference optical beam originating from a reflection of said light on a reference surface and a measurement optical beam originating from reflections of said light on interfaces of the measurement object, so as to produce a grooved spectrum signal with spectral modulation frequencies;
displacement means for varying the relative optical length of the measurement optical beam and the reference optical beam, and means for measuring an item of position information representative of said relative optical length;
electronic and calculating means arranged for determining at least one spectral modulation frequency representative of an optical path difference between the measurement optical beam and the reference optical beam, and for determining, by exploiting said item of position information and said at least one spectral modulation frequency, at least one height and/or thickness on said measurement object; and
second optical means for measuring distance and/or thickness with a second measurement beam incident on the measurement object on a second face opposite the measurement beam.

2. The device according to claim 1, comprising a measuring head with the reference surface, and means suitable for translational movement for relative displacement of said measuring head and the measurement object in a direction substantially parallel to an optical axis of the measurement optical beam.

3. The device according to claim 2, which comprises a reference surface in the form of a semi-reflective plate inserted in the path of the measurement optical beam.

4. The device according to claim 2, which comprises a measuring head with a beam-splitting optical element suitable for generating a separate measurement optical beam and a separate reference optical beam.

5. The device according to claim 4, which comprises a measuring head with a first interferometer of one of the following types: Mirau, Linnick, Michelson, for generating the measurement optical beam and the reference optical beam.

6. The device according to claim 1, which further comprises second translation means suitable for the relative displacement of the measurement optical beam and the measurement object in a plane substantially perpendicular to an optical axis of the measurement beam.

7. The device according to claim 1, which further comprises a support suitable for receiving the measurement object, and a reference object with a known height and/or known thicknesses arranged on or forming part of said support.

8. The device according to claim 1, which comprises a first low-coherence interferometer illuminated by a polychromatic light, which emits light in the visible spectrum.

9. The device according to claim 1, which comprises second optical means for measuring distance and/or thickness of one of the following types:
spectral-domain low-coherence interferometer,
chromatic confocal system.

10. The device according to claim 1, which comprises second optical means for measuring distance and/or thickness with a time-domain low-coherence interferometer.

11. The device according to claim 10, in which the time-domain low-coherence interferometer comprises a light source emitting in the infrared.

12. The device according to claim 10, in which the time-domain low-coherence interferometer comprises a double Michelson interferometer with an encoding interferometer and a decoding interferometer, and a measurement optical fibre with a collimator for generating the second measurement optical beam.

13. A method for measuring heights and/or thicknesses on a measurement object such as a wafer, using a first low-coherence interferometer illuminated by a polychromatic light and arranged for combining, in a spectrometer, a reference optical beam originating from reflection of said light on a reference surface and a measurement optical beam originating from reflections of said light on interfaces of the measurement object, so as to produce a grooved spectrum signal with spectral modulation frequencies,
comprising:
measuring an item of position information representative of the relative optical length of the measurement optical beam and the reference optical beam;
determining at least one spectral modulation frequency representative of an optical path difference between the measurement optical beam and the reference optical beam;
determining, by exploiting said item of position information and said at least one spectral modulation frequency, at least one height and/or thickness on said measurement object; and
measuring a second item of information on height and/or thicknesses using second optical means for measuring distance and/or thickness with a second measurement beam incident on the object to be measured on a second face opposite the measurement beam, so as to determine an item of thickness information of said object to be measured.

14. The method according to claim 13, which comprises a step of identifying the spectral modulation frequencies the value of which varies with a variation of the relative optical length of the measurement optical beam and the reference optical beam.

15. The method according to claim 13, which further comprises a step of varying the relative optical length of the measurement optical beam and the reference optical beam so as to obtain at least one spectral modulation frequency in a predetermined range of values.

16. The method according to claim 13, which further comprises steps of:
calculating a spectral modulation signal representative of the amplitude of the Fourier transform of the grooved spectrum signal; and
identifying amplitude peaks representative of spectral modulation frequencies in said spectral modulation signal.

17. The method according to claim 13, which further comprises a calibration step comprising measurement of height and/or thickness on a reference object of known height and/or thickness, so as to establish a relationship between at least one item of position information of the reference surface, at least one spectral modulation frequency, and at least one height and/or thickness.

18. The method according to claim 13, in which the measurement of a second item of information on height and/or thicknesses comprises steps of:
generating the second measurement optical beam and a reference optical beam by means of a measurement optical fibre and a collimator; and
determining optical path differences between the second measurement optical beam reflected on the measurement object and the reference beam, using a double Michelson interferometer with an encoding interferometer and a decoding interferometer provided with a time delay line.
